(19) United States
(12) Patent Application Publication
(10) Pub. No.: US 2022/0198151 A1
(43) Pub. Date: Jun. 23, 2022

(54) DIALOGUE SYSTEM, A VEHICLE HAVING THE SAME, AND A METHOD OF CONTROLLING A DIALOGUE SYSTEM

(71) Applicants: HYUNDAI MOTOR COMPANY, Seoul (KR); KIA CORPORATION, Seoul (KR)

(72) Inventor: Sung Soo Park, Incheon (KR)

(73) Assignees: HYUNDAI MOTOR COMPANY, Seoul (KR); KIA CORPORATION, Seoul (KR)

(21) Appl. No.: 17/525,585

(22) Filed: Nov. 12, 2021

(30) Foreign Application Priority Data
Dec. 19, 2020 (KR) 10-2020-0185588

(51) Int. Cl. G06F 40/35; G06F 40/44; G10L 15/08; G10L 15/22

(52) U.S. Cl. CPC G06F 40/35; G06F 40/44; G10L 2015/223; G10L 15/22; G10L 15/08

(57) ABSTRACT

The disclosure relates to a dialogue system, a vehicle having the same, and a method of controlling the same. The dialogue system includes a storage configured to store target information about a target and a target value for ambiguous language; a first input device configured to receive speech signals; and a dialogue manager configured to: convert the speech signals received in the first input device into text; determine a user's intention based on the received speech signals; and based on determining that the determined user's intention corresponds to a request intention and the converted text corresponds to the ambiguous language, obtain the target and the target value corresponding to the ambiguous language from the target information stored in the storage. The dialogue system also includes a result processor configured to generate a response based on the target and the target value obtained from the dialogue manager, and to control an output of the generated response.

### CROSS-REFERENCE TO RELATED APPLICATION(S)

This application is based on and claims priority under 35 U.S.C. § 119 to Korean Patent Application No. 10-2020-0185588, filed on Dec. 29, 2020, the disclosure of which is incorporated herein by reference.

### BACKGROUND

### 1. Field

The disclosure relates to a dialogue system that recognizes a user's intention through dialogue with a user and that provides information or a service needed by the user, a vehicle having the same, and a method of controlling the dialogue system.

### 2. Description of Related Art

For an audio-video-navigation (AVN) device of a vehicle, an air conditioner in the vehicle, or most mobile devices, when providing visual information to a user or receiving a user's input, a small screen and a small button provided therein may cause the user inconvenience.

In particular, during driving of the vehicle, when a user moves his or her hand off a steering wheel or when the user looks up to check visual information or operate devices in the vehicle, it may be a serious danger to the safe driving.

Therefore, when applying a dialogue system to a vehicle, it may be possible to provide services in a more convenient and safer manner, where the dialogue system is capable of recognizing a user's intention through dialogue with the user and provide information or a service desired for the user.

### SUMMARY

An aspect of the disclosure is to provide a dialogue system that recognizes a user's intention for an ambiguous language uttered by a user from existing dialogue information and target information selected by the user, a vehicle having the same, and a method of controlling the dialogue system.

Another aspect of the disclosure is to provide a dialogue system that constructs an experience database from existing dialogue information and target information selected by the user and recognizes the user's intention based on information of the constructed experience database, a vehicle having the same, and a method of controlling the dialogue system.

Additional aspects of the disclosure are set forth in part in the description which follows and, in part, should be apparent from the description or may be learned by practice of the disclosure.

According to an aspect of the disclosure, a dialogue system includes a storage configured to store target information about a target and a target value for ambiguous language. The dialogue system also includes a first input device configured to receive speech signals. The dialogue system also includes a dialogue manager configured to convert the speech signals received in the first input device into text. The dialogue manager is further configured to determine a user's intention based on the received speech signals. The dialogue manager is further configured, based on determining that the determined user's intention corresponds to a request intention and the converted text corresponds to the ambiguous language, to obtain the target and the target value corresponding to the ambiguous language from the target information stored in the storage. The dialogue system also includes a result processor configured to generate a response based on the target and the target value obtained from the dialogue manager, and to control an output of the generated response.

In response to a presence of a speech signal corresponding to a query for the ambiguous language among the received speech signals, the dialogue manager may be configured to update the target information corresponding to the ambiguous language stored in the storage based on the speech signal corresponding to the query.

The dialogue system may further include a second input device configured to receive user inputs except for a speech. In response to a presence of a user input corresponding to a query for the ambiguous language among the user inputs received through the second input device, the dialogue manager may be configured to update the target information corresponding to the ambiguous language stored in the storage based on the user input corresponding to the query.

The dialogue system may further include a second input device configured to receive user inputs except for the speech. The dialogue manager may be configured to obtain a history probability of the target value for each ambiguous language based on selection information of the target value for each ambiguous language received through the first and second input devices. The result processor may be configured to generate a plurality of responses based on the history probability for the obtained target value for each ambiguous language, and to output the generated plurality of responses.

The dialogue manager may be configured to: based on dialogue information with the user, determine whether the ambiguous language exists; in response to determining that the ambiguous language exists, based on the dialogue information, generate the target information for the ambiguous language as experience information based on the dialogue information; and store the generated experience information in the storage.

The ambiguous language may include a language that modifies the target.

According to another aspect of the disclosure, a vehicle includes a first input device configured to receive speech signals. The vehicle also includes a storage configured to store target information about a target and a target value for ambiguous language. The vehicle also includes a dialogue system configured to convert the speech signals received in the first input device into text. The dialogue system is further configured to determine a user's intention based on the received speech signals. The dialogue system is further configured, based on determining that the determined user's intention corresponds to a request intention and the converted text corresponds to the ambiguous language, to obtain the target and the target value corresponding to the ambiguous language from the target information stored in the storage. The dialogue system is further configured to generate a response based on the obtained target and target value. The dialogue system is further configured to control an output of the generated response.

The vehicle may further include a display configured to output the generated response as an image and a speaker configured to output the generated response as audio.

In response to a presence of a speech signal corresponding to a query for the ambiguous language among the received speech signals, the dialogue system is configured to update the target information corresponding to the ambiguous language stored in the storage based on the speech signal corresponding to the query.

The vehicle may further include a second input device configured to receive user inputs except for a speech. In response to a presence of a user input corresponding to a query for the ambiguous language among the user inputs received through the second input device, the dialogue system may be configured to update the target information corresponding to the ambiguous language stored in the storage based on the user input corresponding to the query.

The vehicle may further include a second input device configured to receive user inputs except for a speech. The dialogue system may be configured to obtain a history probability of the target value for each ambiguous language based on selection information of the target value for each ambiguous language received through the first and second input devices. The dialogue system may be configured to generate a plurality of responses based on the history probability for the obtained target value for each ambiguous language. The dialogue system may also be configured to output the generated plurality of responses.

The dialogue system may be configured, based on dialogue information with the user, to determine whether the ambiguous language exists. The dialogue system may be configured, in response to determining that the ambiguous language exists, based on the dialogue information, to generate the target information for the ambiguous language as experience information based on the dialogue information. The dialogue system may be configured to store the generated experience information in the storage.

The vehicle may further include a controller configured to control at least one of an air conditioner, windows, doors, seats, an audio/video/navigation (AVN) device, a heater, a wiper, side mirrors, internal lamps, or external lamps in response to the response output from the dialogue system.

In response to the user's request intent being a destination search request intent, the dialogue system may be configured to generate the target information for the ambiguous language as experience information based on the dialogue information before a restart and the dialogue information after the restart, and to store the generated experience information in the storage.

The dialogue system may be configured to generate experience information based on destination history information, speech recognition usage information, and control information of at least one device.

The dialogue system may be configured to obtain control information for at least one device based on dialogue information according to a passage of time while driving, and to generate experience information based on the obtained control information of at least one device.

According to another aspect of the disclosure, a method of controlling a dialogue system includes receiving a speech signal. The method of controlling the dialogue system also includes converting the received speech signal into text. The method of controlling the dialogue system also includes identifying an intention of a user's utterance based on the converted text. The method of controlling the dialogue system also includes, in response to the identified intention of the user's utterance being a request intention, and the converted text being a text for ambiguous language, obtaining target information corresponding to the ambiguous language based on experience information stored in an experience database. The method of controlling the dialogue system also includes determining an action corresponding to the obtained target information. The method of controlling the dialogue system also includes generating a response corresponding to the determined action. The method of controlling the dialogue system also includes outputting the generated response.

The method may further include generating the experience information based on the output speech signal and the received speech signal and storing the generated experience information in the experience database.

The method may further include, based on receiving user inputs except for a speech through a second input device, determining whether a user input corresponding to a query for the ambiguous language exists among the received user inputs. The method may further include, in response to determining that there is the user input corresponding to the query for the ambiguous language, updating the target information corresponding to the ambiguous language stored in the experience database based on the user input corresponding to the query.

The outputting of the generated response may include: obtaining a history probability of a target value for each ambiguous language based on selection information of the target value for each ambiguous language received through first and second input devices; generating a plurality of responses based on the history probability for the obtained target value for each ambiguous language; and outputting the generated plurality of responses.

### BRIEF DESCRIPTION OF THE DRAWINGS

These and/or other aspects of the disclosure should become apparent and more readily appreciated from the following description of the embodiments, taken in conjunction with the accompanying drawings of which:

FIG. 1 is a view illustrating an interior of a vehicle provided with a dialogue system according to an embodiment.

FIG. 2 is a control configuration diagram of a vehicle provided with a dialogue system according to an embodiment.

FIG. 3 is a detailed configuration diagram of a dialogue system according to an embodiment.

FIG. 4 is a detailed configuration diagram of an input processor of a dialogue system according to an embodiment.

FIG. 5 is a detailed configuration diagram of a dialogue manager of a dialogue system according to an embodiment.

FIG. 6 is a view illustrating an ambiguity analysis mechanism of an ambiguity solver of a dialogue system according to an embodiment.

FIGS. 7A and 7B are views of obtaining a usage history and a history probability for a target-specific ambiguous language corresponding to a user's intention in a dialogue system according to an embodiment.

FIG. 8 is a view of obtaining experience information from dialogue information between a dialogue system and a user according to an embodiment.

FIG. 9A is a view of a dialogue for searching a destination between a dialogue system and a user according to an embodiment.

FIG. 9B is a view of updating experience information from the dialogue information of FIG. 9A.

FIG. 10A is a view of a dialogue for controlling an air conditioner between a dialogue system and a user according to an embodiment.

FIG. 10B is a view of updating experience information from the dialogue information of FIG. 10A.

FIG. 11 is a view of an experience database of a dialogue system according to an embodiment.

FIG. 12 is a detailed configuration diagram of a result processor of a dialogue system according to an embodiment.

FIGS. 13A and 13B are views illustrating response generation in a dialogue response generator of a dialogue system according to an embodiment.

FIG. 14 is a control flowchart of a dialogue system according to an embodiment.

### DETAILED DESCRIPTION

Like reference numerals refer to like elements throughout the specification. Not all elements of the embodiments of the disclosure are described, and the description of what is commonly known in the art or what overlap each other in the embodiments has been omitted. The terms as used throughout the specification, such as “˜ part,” “˜ module,” “˜ member,” “˜ block,” and the like, may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It should be further understood that the term “connect” and its derivatives refer both to direct and indirect connection, and the indirect connection includes a connection over a wireless communication network.

The terms “include (or including)” and “comprise (or comprising)” are inclusive or open-ended and do not exclude additional or unrecited elements or method steps, unless otherwise mentioned.

It should be understood that, although the terms first, second, third, and the like, may be used herein to describe various elements, components, regions, layers, and/or sections, these elements, components, regions, layers, and/or sections should not be limited by these terms. These terms are only used to distinguish one element, component, region, layer, or section from another region, layer, or section.

It should be understood that the singular forms “a,” “an,” and “the” include plural references unless the context clearly dictates otherwise.

Reference numerals used for method steps are merely used for convenience of explanation but not used to limit an order of the steps. Thus, unless the context clearly dictates otherwise, the written order may be practiced otherwise. When a component, device, element, or the like of the present disclosure is described as having a purpose or performing an operation, function, or the like, the component, device, or element should be considered herein as being “configured to” meet that purpose or to perform that operation or function.

Hereinafter, an operation principle and embodiments of the disclosure are described with reference to accompanying drawings.

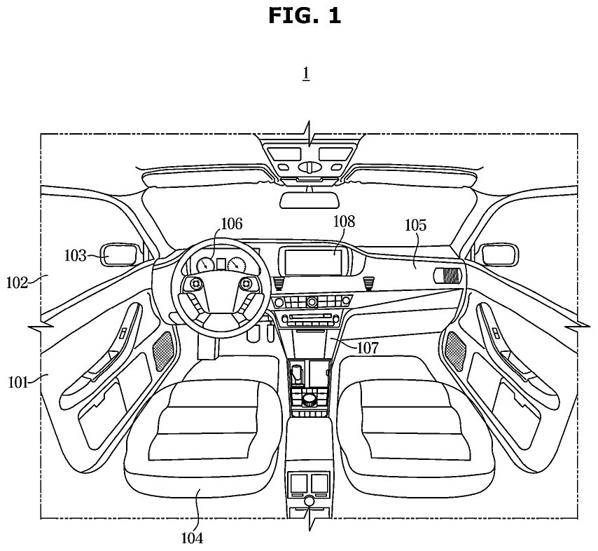

FIG. 1 is a view illustrating an interior of a vehicle provided with a dialogue system according to an embodiment.

Referring to FIG. 1, a vehicle 1 may include a body with exterior and interior parts and a chassis, which is a part of the vehicle 1 except for the body, on which mechanical devices required for driving are installed.

The exterior parts of the body may include front, rear, left and right doors 101, window glasses 102 (or windows) installed on the front, rear, left and right doors 101, and side mirrors 103 that provides a driver of the vehicle 1 with a field of view behind the vehicle 1.

The interior parts of the body may include seats 104 for passengers to sit thereon, a dashboard 105, and an instrument panel 106 (i.e., a cluster) placed on the dashboard 105 and equipped with a tachometer, a speedometer, a coolant thermometer, a fuel gauge, a turn indicator, a high light indicator, a warning light, a seat belt warning light, an odometer, an automatic shift selector light, a door open warning light, an engine oil warning light, and a fuel shortage warning light. The interior parts of the body may also include a center fascia 107 with a throttle for an audio system and a heater/air conditioner.

The center fascia 107 may be equipped with a vent, a lighter, an audio/video/navigation (AVN) device 108, or the like. The AVN 108 may be a vehicle terminal. Hereinafter, the AVN 108 is described as the vehicle terminal.

The vehicle terminal 108 may calculate a current position of the vehicle 1 based on position information provided by a plurality of satellites and display the current position by matching the position information with a map.

In addition, the vehicle terminal 108 may receive a destination from a user, perform route search from the current position to a destination based on a route search algorithm, display the searched route by matching the map, and guide the user to the destination along the route.

The vehicle terminal 108 may perform a speech recognition function. The vehicle terminal 108 may receive an operation command through speech recognition or an address to a destination through speech recognition and select any one of a plurality of previously stored addresses through speech recognition.

The chassis of the vehicle 1 further includes a power generation device, a power transmission device, a traveling device, a steering device, a braking device, a suspension device, a transmission device, a fuel device, front and rear wheels, and the like.

In addition, various safety devices are provided in the vehicle 1 for the safety of occupants. Vehicle stabilization devices may include various types of safety, such as an airbag control device in the event of a vehicle collision, and an electronic stability control device (ESC) that controls the vehicle's posture during acceleration or cornering of the vehicle 1.

The vehicle 1 may further include a sensing device, such as a proximity sensor for detecting an obstacle or another vehicle in the rear or sides of the vehicle 1, a rain sensor for detecting rainfall and the amount of rainfall, and the like.

In addition, the vehicle 1 may selectively include an electronic device (i.e., a load), such as a hands-free device, a global positioning system (GPS), an audio device, a Bluetooth device (i.e., a communication device), a rear camera, a charging device, a black box, a heating wire of a seat, a high pass device, and the like. The electronic device may receive the operation command through speech recognition.

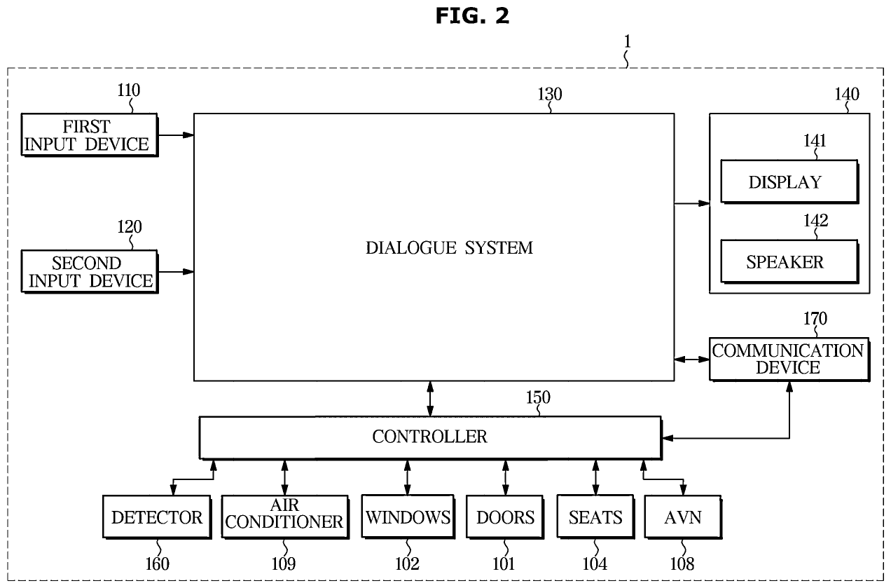

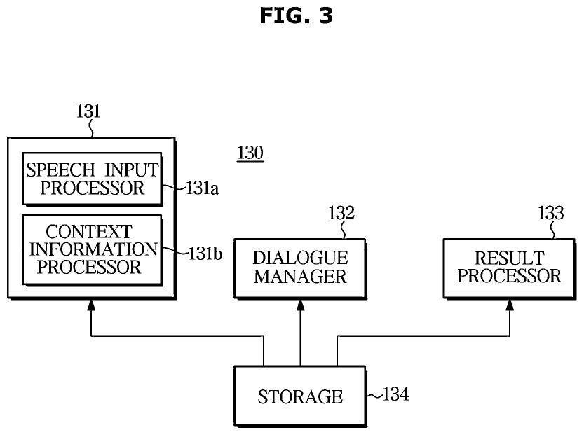

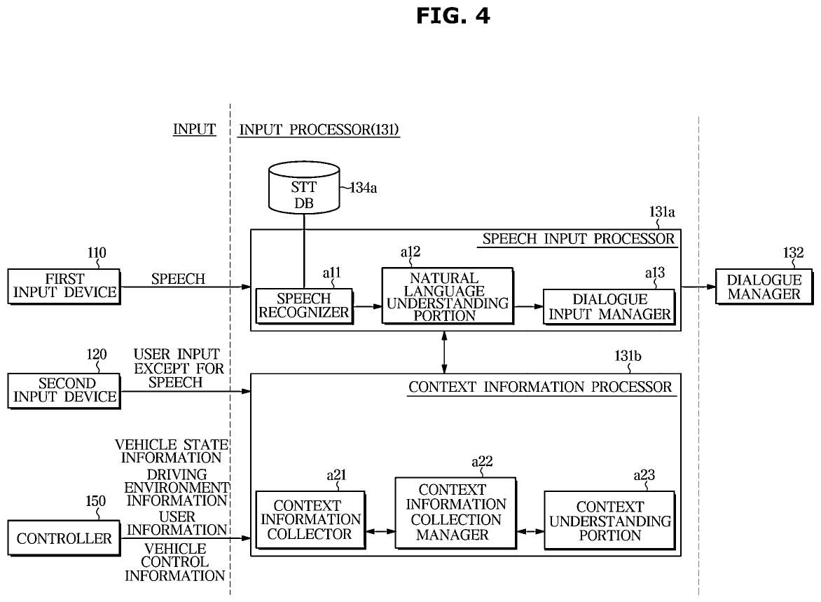

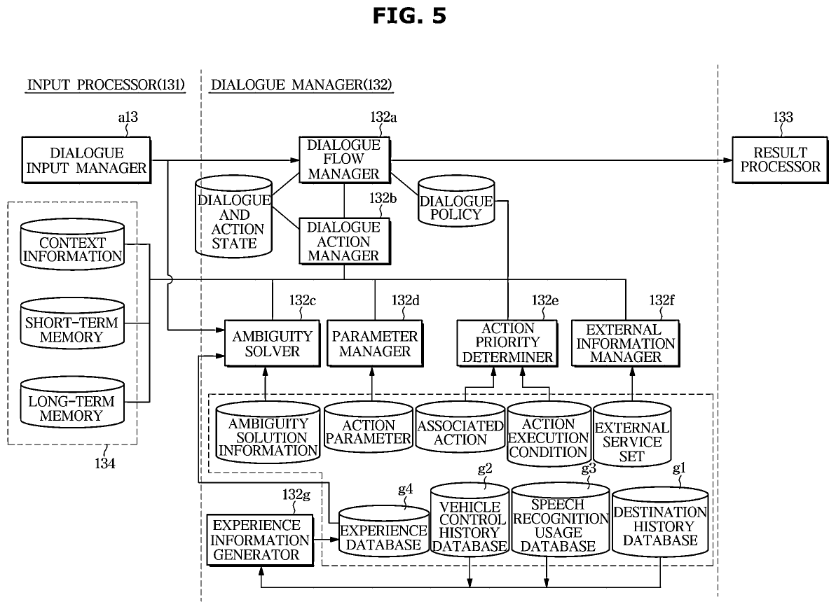

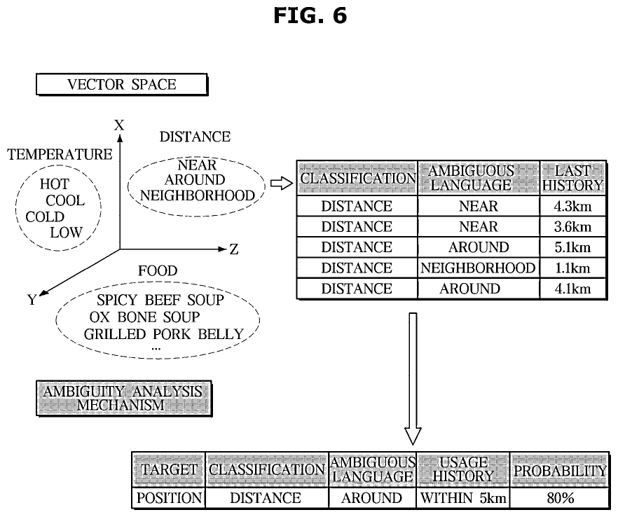

FIG. 2 is a control configuration diagram of a vehicle provided with a dialogue system according to an embodiment. FIG. 3 is a detailed configuration diagram of a dialogue system according to an embodiment. FIG. 4 is a detailed configuration diagram of an input processor of a dialogue system according to an embodiment. FIG. 5 is a detailed configuration diagram of a dialogue manager of a dialogue system according to an embodiment. FIG. 6 is a detailed configuration diagram of a result processor of a dialogue system according to an embodiment.

Referring to FIG. 2, the vehicle 1 may include a first input device 110, a second input device 120, a dialogue system 130, an output device 140, a controller 150, a detector 160, a communication device 170, and a plurality of electronic devices 101, 102, 104, 108, and 109.

The first input device 110 may receive a user control command as a speech (i.e., speaking command). The first input device 110 may include a microphone configured to receive a sound and then covert the sound into an electrical signal.

For effective speech input, the first input device 110 may be mounted to a head lining, but the first input device 110 may be mounted to the dashboard 105 or a steering wheel. In addition, the first input device 110 may be mounted to any position as long as a position is appropriate for receiving a user's speech.

The second input device 120 may receive the user command through user manipulation. The second input device 120 may include at least one of buttons, keys, switches, touch pads, pedals, or levers.

The second input device 120 may also include a camera that captures the user. The user's gesture, facial expression, or gaze direction used while inputting a command may be recognized through an image captured by the camera. Alternatively, it is also possible to grasp the user's state (such as drowsiness) through the image captured by the camera.

The second input device 120 may be implemented as a touch panel, and a display 141 of the output device 140 may be implemented as a flat panel display panel such as an LCD. In other words, the display 141 of the second input device 120 and the output device 140 may be implemented as a touch screen in which the touch panel and the flat panel display panel are integrally formed.

The second input device 120 may further include a jog dial for inputting a movement command and a selection command of a cursor displayed on the display 141.

The second input device 120 may transmit a signal for the buttons or jog dial operated by the user to the controller 150 and also transmit a signal of a position touched by the touch panel to the controller 150.

The dialogue system 130 may recognize the user's intention and context using the user's speech input via the first input device 110, a user's command input via the second input device 120, and a variety of information input via the controller 150. The dialogue system 130 may output a response to perform an action corresponding to the user's intention.

The dialogue system 130 may convert the user's speech input through the first input device 110 into text and determine whether the converted text is text for an ambiguous language.

An ambiguous language may be a language without a reference for determining user's intention or a language lacking a basis for setting the reference.

The ambiguous language may include a modifier that semantically limits a target object.

For example, the ambiguous language may include: around, surrounding, near, far, and the like, which modify a distance; short, long, and the like, which modify a time; and cheap, expensive, high price, low price, and the like, which modify a cost. The ambiguous language may include many, few, appropriate, and the like, which modify a quantity, and may include large, small, high, low, and the like, which modify a size or a level.

In relation to a taste level, the distance, the time, the cost, a temperature, an air volume, a wind direction, a volume, and the like, when a target value such as a control value or a set value of a target in an uttered language is not expressed numerically, the dialogue system 130 may determine that the uttered language (i.e., user's speech) is the ambiguous language.

In other words, the ambiguous language may be a language in which a target value of the target for determining a destination or a target value for determining a control value of a control object is ambiguous.

The dialogue system 130 may determine that the uttered language (i.e., user's speech) is the ambiguous language when the uttered language is included in a higher-level term in a type of object.

For example, the ambiguous language may include meat, Korean food, Western food, Chinese food, Japanese food, a region name, and a country name.

When it is determined that the converted text is a text for the ambiguous language, the dialogue system 130 may recognize the user's intention for the ambiguous language based on the stored dialogue information and the user's selection information.

When it is determined that the converted text is the text for the ambiguous language, the dialogue system 130 may recognize the user's intention for the ambiguous language based on information stored in an experience database.

The dialogue system 130 may output a response for performing an action on the user's uttered language based on the user's intention and context.

Vehicle information input through the controller 150 may include vehicle state information or surrounding context information obtained through various sensors of the detector 160 provided in the vehicle 1 and may also include information basically stored in the vehicle 1, such as the type of vehicle.

The dialogue system 130 may recognize the user's real intention and proactively provide information corresponding to the intention by considering a content, which is not uttered by the user, based on pre-obtained information. Therefore, it may be possible to reduce the dialogue steps and time for providing the service desired by the user.

As illustrated in FIG. 3, the dialogue system 100 may include an input processor 131, a dialogue manager 132, a result processor 133, and a storage 134.

The input processor 131 may process a user input including the user's speech and input except for the speech, information related to the vehicle 1, or input including information related to the user.

The input processor 131 may receive two kinds of input such as a user's speech and an input except for the speech. The input except for the speech may include recognizing a user's gesture, an input except for the user's speech input by operations of the input devices 110 and 120, the vehicle state information indicating a vehicle state, driving environment information related to driving information of the vehicle 1, and user information indicating a user's state. In addition, other than the above-mentioned information, information related to the user and the vehicle 1 may be input to the input processor 131, as long as information is used for recognizing a user's intention or providing a service to a user or the vehicle 1. The user may include vehicle occupant(s) such as the driver and passenger(s).

The input processor 131 may convert the user's speech into an utterance in the text type by recognizing the user's speech and recognize the user's intention by applying a natural language understanding algorithm to the user utterance.

The input processor 131 may collect information related to the vehicle state or the driving environment of the vehicle except for the user speech and then understand the context using the collected information.

The input processor 131 may transmit the user's intention, which is obtained by the natural language understanding technology, and the information related to the context to the dialogue manager 132.

The dialogue manager 132 may use the processing result of the input processor 131 to grasp the user's intention or the state of the vehicle and determine the action corresponding to the user's intention or the state of the vehicle.

The dialogue manager 132 may determine whether the text converted by the input processor 131 is text for the ambiguous language of the user's request intent. When it is determined that the converted text is the text for the ambiguous language of the user's request intent, the dialogue manager 132 may recognize the user's intention for the ambiguous language based on the stored dialogue information and the user's selection information.

The dialogue manager 132 may control the output of query information for the ambiguous language. When it is determined that the text processed by the input processor 131 is text corresponding to the query information, the dialogue manager 132 may store the determined text as a target value corresponding to the ambiguous language in the storage 134.

The dialogue manager 132 may obtain a history probability of the target value for each ambiguous language based on selection information of the target value for each ambiguous language received through the first and second input devices.

The text processed by the input processor 131 is a text for a speech signal received through the first input device and may be target information selected by the user.

In other words, the dialogue manager 132 may update experience information stored in the experience database.

The stored dialogue information and the user's selection information may be information stored in the experience database.

The dialogue manager 132 may determine the action corresponding to the user's intention or the current context based on the user's intention, the information related to the context transmitted from the input processor 131, and whether the ambiguous language is determined. The dialogue manager 132 may manage parameters that are needed to perform the corresponding action.

According to forms, the action may represent all kinds of actions for providing a certain service, and the kinds of the action may be determined in advance.

The dialogue manager 132 may transmit information related to the determined action to the result processor 133.

The result processor 133 outputs a system utterance for continuing the dialogue or providing a specific service according to the output result of the dialogue manager 132.

The result processor 133 generates and outputs a dialogue response and a command that is needed to perform the transmitted action. The dialogue response may be output in text, image, or audio type. When the command is output, a service such as vehicle control and external content provision, corresponding to the output command, may be performed.

The storage 134 may store various information necessary for the dialogue system 130 to perform various operations.

The storage 134 may store a variety of information for the dialogue processing and the service provision. For example, the storage 134 may pre-store information related to domains, actions, speech acts and entity names used for the natural language understanding and a context understanding table used for understanding the context from the input information. In addition, the storage 140 may pre-store data detected by a sensor provided in the vehicle, information related to a user, and information needed for the action.

The storage 134 may include an STT (Speech To Text) database (DB) and a domain/action inference rule DB. The domain/action inference rule DB may include predefined actions such as road guidance, vehicle condition check, gas station recommendation, and the like. Accordingly, the action corresponding to the user's utterance, i.e., an action intended by the user, may be extracted from predefined actions.

In addition, the storage 134 may include an associated action DB that stores actions associated with events occurring in the vehicle 1.

The storage 134 may store past dialogue information and store the target information corresponding to the user's intention and the ambiguous language but may store the target information selected by the user among the target information.

The storage 134 may store past dialogue information for each user and store the target information selected for each user from among the target information corresponding to the user's intention and the ambiguous language.

The storage 134 may store the past dialogue information, user's intention information, the target information, and the selected target information as the experience information. The storage 134 may include an experience database g4 (refer to FIG. 5) for storing the experience information.

The storage 134 may store destination history information of the destination received by the user, vehicle control history information for vehicle control while driving or parking, and speech recognition usage information recognizing the user's speech. The storage 134 may include a destination history database g1 (see FIG. 5), a vehicle control history database g2 (see FIG. 5), and a speech recognition usage database g3 (see FIG. 5).

The vehicle control history information for vehicle control while driving or parking may be vehicle control information performed during the speech recognition.

The destination history information may include the destination information input through the second input device and the destination information input by speech through the first input device.

As mentioned above, the dialogue system 130 may provide dialogue processing technologies that are proper for vehicle environments. All components or some components of the dialogue system 130 may be contained in the vehicle 1.

When applying the dialogue processing technologies appropriate for the vehicle environments, such as the dialogue system 130, it may easily recognize and respond to a key context by which the driver directly drives the vehicle. It may be possible to provide a service by applying a weight to a parameter affecting the driving, such as gasoline shortages and drowsy driving, or it may be possible to easily obtain information, e.g., a driving time and destination information, which is needed for the service, based on a condition in which the vehicle 1 moves to the destination in most cases.

The detailed configuration of the dialogue system 130 is described below with reference to FIGS. 4, 5, and 6.

The output device 140 is a device configured to provide an output in a visual, auditory or tactile manner, to a talker. The output device 140 may include the display 141 and a speaker 142 provided in the vehicle 1.

The display 141 and the speaker 142 may output the response to the user's utterance, a question about the user, or information requested by the user, in the visual or auditory manner. In addition, it may be possible to output a vibration by installing a vibrator in the steering wheel.

The display 141 may be implemented by any one of various display devices, e.g., Liquid Crystal Display (LCD), Light Emitting Diode (LED), Plasma Display Panel (PDP), Organic Light Emitting Diode (OLED), and Cathode Ray Tube (CRT).

The display 141 may display a map related to driving information, road environment information, and route guidance information according to the instructions of the controller 150. In other words, the display 141 may display the map in which the current position of the vehicle 1 is matched, the operation state, and other additional information.

The display 141 may display information related to a telephone call or information related to music reproduction and may also display an external broadcast signal as the image.

The display 141 may also display a dialogue screen in a dialogue mode.

The speaker 142 may allow dialogue with the user inside the vehicle 1 or output the sound necessary for providing the service desired by the user.

The speaker 142 may output a speech for navigation route guidance, the sound or the speech contained in the audio and video contents, the speech for providing information or service desired by the user, and a system utterance generated as a response to the user's utterance.

Further, according to the response output from the dialogue system 130, the controller 150 may control the vehicle 1 to perform the action corresponding to the user's intention or the current context.

As well as the information obtained by the detector 160 provided in the vehicle 1, the vehicle 1 may collect information obtained from an external content server or an external device via the communication device 170, e.g., driving environment information and user information such as traffic conditions, weather, temperature, passenger information and driver personal information. The vehicle 1 may transmit the information to the dialogue system 130.

Information obtained by the detector 160 provided in the vehicle 1, e.g., a remaining amount of fuel, an amount of rain, a rain speed, surrounding obstacle information, a speed, an engine temperature, a tire pressure, current position, and the like, may be input to the dialogue system 130 via the controller 150.

According to the response output from the dialogue system 130, the controller 150 may control the air conditioner 109, windows 102, doors 101, the seats 104, or the AVN 108 provided in the vehicle 1. In addition, the controller 150 may control at least one of the audio system/device, a heater, a wiper, the side mirror, or interior and exterior lamps according to the response output from the dialogue system 130.

The controller 150 may include a memory in which a program for performing the above-described operation and the operation described below is stored, and a processor for executing the stored program. At least one memory and one processor may be provided, and when a plurality of memories and processors are provided, they may be integrated on one chip or physically separated.

The detector 160 may include a plurality of sensors and transmit the vehicle state information or the driving environment information such as the remaining amount of fuel, rainfall, rainfall speed, surrounding obstacle information, tire pressure, current position, engine temperature, vehicle speed, and the like, detected by the plurality of sensors to the controller 150.

The communication device 170 may include at least one communication module configured to communicate with internal and external devices of the vehicle 1. For example, the communication device 170 may include at least one of a short-range communication module, a wired communication module, or a wireless communication module. The external device may include a server, another vehicle, a user terminal, infrastructure, and the like.

The short-range communication module may include a variety of short range communication modules, which is configured to transmit and receive a signal using a wireless communication module in the short range, e.g., Bluetooth module, Infrared communication module, Radio Frequency Identification (RFID) communication module, Wireless Local Access Network (WLAN) communication module, NFC communications module, and ZigBee communication module.

The wired communication module may include a variety of wired communication modules, e.g., Local Area Network (LAN) module, Wide Area Network (WAN) module, or Value Added Network (VAN) module and a variety of cable communication modules, e.g., Universal Serial Bus (USB), High Definition Multimedia Interface (HDMI), Digital Visual Interface (DVI), recommended standard 232 (RS-232), power line communication or plain old telephone service (POTS).

The wireless communication module may include a wireless communication module supporting a variety of wireless communication methods, e.g., Wifi module, Wireless broadband module, global System for Mobile (GSM) Communication, Code Division Multiple Access (CDMA), Wideband Code Division Multiple Access (WCDMA), Time Division Multiple Access (TDMA), Long Term Evolution (LTE), 4G and 5G.

In addition, the communication device may further include an internal communication module for communication between electronic devices in the vehicle 1. The communication protocol of the vehicle 1 may use Controller Area Network (CAN), Local Interconnection Network (LIN), FlexRay, and Ethernet.

As illustrated in FIG. 4, the input processor 131 may include a speech input processor 131a and a context information processor 131b.

The speech input processor 131a may include a speech recognizer a11, a natural language understanding portion a12, and a dialogue input manager a13.

The speech recognizer all may output the utterance in the text type by recognizing the input user's speech. The speech recognizer all may include a speech recognition engine and the speech recognition engine may recognize a speech uttered by a user by applying a speech recognition algorithm to the input speech and generate a recognition result.

Since the input speech is converted into a more useful form for the speech recognition, the speech recognizer all may detect an actual speech section included in the speech by detecting a start point and an end point from the speech signal. This is called End Point Detection (EPD).

The speech recognizer all may extract the feature vector of the input speech from the detected section by applying the feature vector extraction technique, e.g., Cepstrum, Linear Predictive Coefficient: (LPC), Mel Frequency Cepstral Coefficient (MFCC) or Filter Bank Energy.

The speech recognizer all may obtain the results of recognition by comparing the extracted feature vector with a trained reference pattern. The speech recognizer all may use an acoustic model of modeling and comparing the signal features of a speech and may use a language model of modeling a linguistic order relation of a word or a syllable corresponding to a recognition vocabulary. For this, the storage 134 may store the acoustic model and language model DB.

The acoustic model may be classified into a direct comparison method of setting a recognition target to a feature vector model and comparing the feature vector model to a feature vector of a speech signal and a statistical method of statistically processing a feature vector of a recognition target.

The speech recognizer all may use any one of the above-described methods for the speech recognition. For example, the speech recognizer all may use an acoustic model to which the Hidden Markov Model (HMM) is applied or a N-best search method in which an acoustic model is combined with a speech model. The N-best search method may improve recognition performance by selecting N recognition result candidates or less using an acoustic model and a language model and then re-estimating an order of the recognition result candidates.

The speech recognizer all may calculate a confidence value to ensure reliability of a recognition result. A confidence value may be criteria representing how a speech recognition result is reliable. For example, the confidence value may be defined, with respect to a phoneme or a word that is a recognized result, as a relative value of probability at which the corresponding phoneme or word has been uttered from different phonemes or words. Accordingly, a confidence value may be expressed as a value between 0 and 1 or between 1 and 100.

When the confidence value is greater than a predetermined threshold value, the speech recognizer 111a may output the recognition result to allow an operation corresponding to the recognition result to be performed. When the confidence value is equal to or less than the threshold value, the speech recognizer all may reject the recognition result.

The speech recognizer all may be corrected as the utterance in the text type corresponding to the user's intention and context based on the information stored in a STT DB 134a, rather than understanding the utterance in the text type by the speech recognizer all as it is.

The STT DB 134a may be provided in the storage 134.

The STT DB 134a may store at least one speech signal corresponding to text having the same meaning.

The speech recognizer all may include a STT module that accurately recognizes the action.

The speech recognizer all may receive information from the STT DB 134a for converting speech to text and update information stored in the STT DB 134a based on the speech recognition result.

The speech recognizer all may identify a similarity level between the speech signal in the STT DB 134a and the received speech signal and identify at least one speech signal having the similarity level above a certain level among the identified similarities. The speech recognizer all may identify texts corresponding to at least one speech signal.

The speech recognizer all may perform STT learning based on the recognition result of speech and update information in the STT DB 134a based on the learning result.

The speech recognizer all may also set STT conversion parameters based on the speech recognition result in a state where the user's intention or context is not analyzed and store the set STT parameters in the STT DB 134a.

The speech recognizer all may improve the vocabulary comprehension of the speech uttered by the user and accurately grasp the user's intention.

The utterance in the text type that is the recognition result of the speech recognizer all may be input as the natural language understanding portion a12.

The natural language understanding portion a12 may apply a natural language understanding technology to the utterance to grasp the user's intention contained in the utterance.

The natural language understanding portion a12 may identify an intention of user's utterance included in an utterance language by applying the natural language understanding technology. Therefore, the user may input a control command through a natural dialogue, and the dialogue system 130 may also induce the input of the control command and provide a service needed by the user via the dialogue.

The natural language understanding portion a12 may perform morphological analysis on the utterance in the form of text. A morpheme is the smallest unit of meaning and represents the smallest semantic element that can no longer be subdivided. Thus, the morphological analysis is a first step in natural language understanding and transforms the input string into the morpheme string.

The natural language understanding portion a12 may extract a domain from the utterance based on the morphological analysis result. The domain may be used to identify a subject of a user utterance language, and the domain indicating a variety of subjects, e.g., route guidance, weather search, traffic search, schedule management, fuel management and air conditioning control, may be stored as a database.

The natural language understanding portion a12 may recognize an entity name from the utterance. The entity name may be a proper noun, e.g., people names, place names, organization names, time, date, and currency, and the entity name recognition may be configured to identify an entity name in a sentence and determine the type of the identified entity name. The natural language understanding portion a12 may extract important keywords from the sentence using the entity name recognition and recognize the meaning of the sentence.

In addition, the entity name may further include a business name, a building name, and the like.

The natural language understanding portion a12 may recognize the ambiguous language whose standard or target is not clear from the utterance.

The natural language understanding portion a12 may analyze a speech act contained in the utterance. The speech act analysis may be configured to identify the intention of the user utterance, e.g., whether a user asks a question, whether a user asks or makes a request, whether a user responds, or whether a user simply expresses an emotion.

The natural language understanding portion a12 extracts an action corresponding to an intention of the user's utterance. The natural language understanding portion a12 may identify the intention of the user's utterance based on the information, e.g., domain, entity name, and speech act and extract an action corresponding to the utterance. The action may be defined by an object and an operator.

The natural language understanding portion a12 may extract a parameter related to the action execution. The parameter related to the action execution may be an effective parameter that is directly required for the action execution or an ineffective parameter that is used to extract the effective parameter.

The natural language understanding portion a12 may extract a tool configured to express a relationship between words or between sentences, e.g., parse-tree.

The morphological analysis result, the domain information, the action information, the speech act information, the extracted parameter information, the entity name information and the parse-tree, which is the processing result of the natural language understanding portion a12, may be transmitted to the dialogue input manager a13.

The ambiguous language determination information, which is the processing result of the natural language understanding portion a12, may be transmitted to the dialogue input manager a13.

The dialogue input manager a13 may transmit the natural language understanding result and context information to the dialogue manager 120.

The context information processor 131b may include a context information collector a21, a context information collection manager a22, and a context understanding portion a23.

The context information collector a21 may collect information from the second input device 120 and the controller 150.

The context information collector a21 may periodically collect data or collect data only when a certain event occurs. In addition, the context information collector a21 may periodically collect data and then additionally collect data when a certain event occurs. Further, when receiving a data collection request from the context information collection manager a22, the context information collector a21 may collect data.

The input except for the speech of the second input device 120 may be contained in the context information. In other words, the context information may include the vehicle state information, the driving environment information, and the user information.

The vehicle state information may include information, which indicates the vehicle state and is obtained by a sensor provided in the vehicle 1, and information that is related to the vehicle, e.g., the fuel type of the vehicle, and stored in the vehicle 1.

The driving environment information may be information obtained by the sensor provided in the vehicle 1. The driving environment information may include image information obtained by a front camera, a rear camera or a stereo camera, obstacle information obtained by a sensor, e.g., a radar, a LiDAR, an ultrasonic sensor, and information related to an amount of rain, and rain speed information obtained by a rain sensor.

The driving environment information may further include traffic state information, traffic light information, and adjacent vehicle access or adjacent vehicle collision risk information, which is obtained via Vehicle to Everything (V2X).

The user information may include information related to user state that is measured by a camera provided in the vehicle 1 or a biometric reader, information related to a user that is directly input using the input devices 110 and 120 provided in the vehicle 1 by the user, information related to the user and stored in the external content server, and information stored in mobile devices connected to the vehicle 1.

The context information collector a21 may collect the vehicle control information, such as vehicle acceleration, deceleration, steering, stop, parking, reverse, shift, and control information of in-vehicle device.

The context information collection manager a22 may manage the collection of context information.

The context information collection manager a22 may collect the necessary context information through the context information collector a21 and transmit a confirmation signal to the context understanding portion a23.

When the context information collection manager a22 determines that a certain event occurs since data collected by the context information collector a21 meets a predetermined condition, the context information collection manager a22 may transmit an action trigger signal to the context understanding portion a23.

The context understanding portion a23 may understand the context based on the natural language understanding result and the collected context information.

The context understanding portion a23 may search a context understating table for searching for context information related to the corresponding event. When the searched context information is not stored in the context understating table, the context understanding portion a23 may transmit a context information request signal to the context information collection manager a22, again.

The context understanding portion a23 may refer to context information for each action stored in the context understanding table to determine what context information is associated with performing an action corresponding to the user's utterance intention.

As illustrated in FIG. 5, the dialogue manager 132 may include a dialogue flow manager 132a, a dialogue action manager 132b, an ambiguity solver 132c, a parameter manager 132d, an action priority determiner 132e, an external information manager 132f, and an experience information generator 132g.

The dialogue flow manager 132a may make a request for generating, deleting, and updating dialogues or actions.

More particularly, the dialogue flow manager 132a may search for whether a dialogue task or an action task corresponding to the input by the dialogue input manager a13 is present in a dialogue and action state DB.

The dialogue and action state DB may be a storage space for managing the dialogue state and the action state, and thus the dialogue and action state DB may store currently progressing dialogue and action and dialogue state and action state related to preliminary actions to be processed. For example, the dialogue and action state DB may store states related to completed dialogue and action, stopped dialogue and action, progressing dialogue and action, and dialogue and action to be processed.

When the domain and the action corresponding to a user utterance is not extracted, the dialogue and action state DB may generate a random task or request that the dialogue action manager 132b refers to the most recently stored task.

When the dialogue task or action task corresponding to the input of the input processor 131 is not present in the dialogue and action state DB, the dialogue flow manager 132a may request that the dialogue action manager 132b generates a new dialogue task or action task.

When the dialogue flow manager 132a manages the dialogue flow, the dialogue flow manager 132a may refer to a dialogue policy DB.

The dialogue policy DB may store a policy to continue the dialogue, wherein the policy may represent a policy for selecting, starting, suggesting, stopping, and terminating the dialogue.

In addition, the dialogue policy DB may store a point of time in which a system outputs a response and may store a policy about a methodology. The dialogue policy DB may store a policy for generating a response by linking multiple services and a policy for deleting previous action and replacing the action with another action.

When the dialogue task or action task corresponding to the output of the input processor 131 is present in the dialogue and action state DB, the dialogue flow manager 132a may request that the dialogue action manager 132b refers to the corresponding dialogue task or action task.

The dialogue action manager 132b may generate, delete, and update a dialogue or action according to the request of the dialogue flow manager 132a.

The dialogue action manager 132b may designate a storage space to the dialogue and action state DB and generate a dialogue task and an action task corresponding to the output of the input processor 131.

When it is impossible to extract a domain and an action from the user's utterance, the dialogue action manager 132b may generate a random dialogue state. In this case, as mentioned below, the ambiguity solver 132c may identify the user's intention based on the content of the user's utterance, the environment condition, the vehicle state, and the user information, and determine an action appropriate for the user's intention.

The ambiguity solver 132c may deal with the ambiguity in the dialogue or in the context. For example, when anaphora, e.g., the person, that place from yesterday, father, mother, grandmother, and daughter-in-law, is contained in the dialogue, there may be ambiguity because it is not clear that the anaphora represents whom or which. In this case, the ambiguity solver 132c may resolve the ambiguity by referring to the context information DB, a long-term memory or a short-term memory, or provide a guidance to resolve the ambiguity.

The ambiguity solver 132c may integrate the surrounding environment information and the vehicle state information together with the user's utterance even if the user's utterance or context is ambiguous. The ambiguity solver 132c may accurately identify and provide the action the user actually wants or the action the user actually needs.

The ambiguity solver 132c may transmit information about the determined action to the dialogue action manager 132b. In this case, the dialogue action manager 132b may update the dialogue and action state DB based on the transmitted information.

When information about the ambiguous language in the utterance for which the user's intention is requested is received from the natural language understanding portion a12, the ambiguity solver 132c may accurately identify the action actually required for the user based on the experience information stored in the experience database g4.

When the user's intention is a destination search request, the action for the ambiguous language during an execution of a navigation mode may be an action for selecting a destination to guide the user.

For example, when the utterance contains an ambiguous language such as surrounding, short, Korean food, and the like, and it is ambiguous whether it refers to a place or to what distance (e.g., target value), the ambiguity solver 132c may refer to the experience DB g4 to resolve the ambiguity or provide a guide for solving it.

When the user's intention is the vehicle control request, the action on the ambiguous language while performing the vehicle control mode may be an action of selecting the target value for controlling the device.

For example, when controlling the in-vehicle device, when it is ambiguous to what extent (e.g., the target value) the ambiguous language refers to, the ambiguity solver 132c may refer to the experience DB g4 to resolve the ambiguity or provide the guide for solving it.

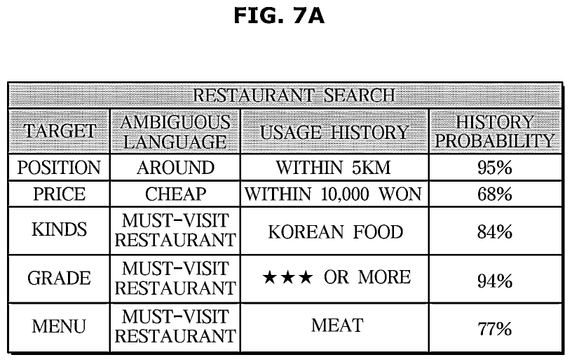

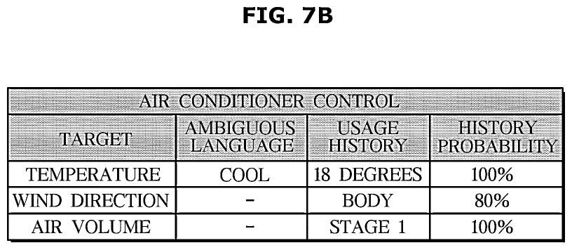

In other words, the ambiguity solver 132c may include obtaining the target information corresponding to the ambiguous language and presenting the guide based on the obtained target information. The target information may include the target and the target value. This is described with reference to FIGS. 6, 7A, and 7B.

The ambiguity solver 132c may perform learning on information stored in the experience database g4.

As illustrated in FIG. 6, the ambiguity solver 132c may convert the ambiguous language into a vector in a vector space through learning, group word distances between similar ambiguous languages in the vector space into information corresponding to the target using a clustering algorithm, and convert into the target for the user's intention to obtain the history probability.

The word distance is as follows.

$$Similarity ( A , B ) = \frac{A \cdot B}{‖ A ‖ \times ‖ B ‖} = ( {\sum }_{i = 1}^{n} {A}_{i} \times {B}_{i} ) / ( \sqrt{{\sum }_{i = 1}^{n} {A}_{i}^{2}} \times \sqrt{{\sum }_{i = 1}^{n} {B}_{i}^{2}} )$$

As illustrated in FIGS. 7A and 7B, the usage history and the history probability for a target-specific ambiguous language corresponding to the user's intention may be obtained.

As illustrated in FIG. 7A, the usage history and the history probability for the target-specific ambiguous language corresponding to a restaurant search may be obtained. As illustrated in FIG. 7B, the usage history and history probability for the target-specific ambiguous language corresponding to air conditioner control may be obtained.

The parameter manager 132d may manage the parameters needed for the action execution.

The parameter manager 132d may search for a parameter used to perform each candidate action (hereinafter referred to as an action parameter) in an action parameter DB.

The parameter value obtained by the parameter manager 132d may be transmitted to the dialogue action manager 132b and the dialogue action manager 132b may update the dialogue and action state DB by adding the parameter value according to the candidate action to the action state.

The parameter manager 132d may obtain parameter values of all of the candidate actions or the parameter manager 132d may obtain only parameter values of the candidate actions, which are determined to be executable by the action priority determiner 132e.

The parameter manager 132d may selectively use an initial value among a different type of initial values indicating the same information. For example, the necessary parameter used for the route guidance may include the current position and the destination, and the alternative parameter may include the type of route. An initial value of the alternative parameter may be stored as a fast route.

The action priority determiner 132e may determine whether an action is executable about a plurality of candidate actions and determine the priority of the plurality of candidate actions.

The action priority determiner 132e may search the relational action DB to search for an action list related to the action or the event contained in the output of the input processor 131. The action priority determiner 125 may then extract the candidate action.

The relational action DB may indicate actions related to each other, a relationship among the actions, an action related to an event, and a relationship among the events. For example, the route guidance, the vehicle state check, and gasoline station recommendation may be classified as the relational action, and a relationship there among may correspond to an association.

The extracted candidate action list may be transmitted to the dialogue action manager 132b and the dialogue action manager 132b may update the action state of the dialogue and action state DB by adding the candidate action list.

The action priority determiner 132e may search for conditions to execute each candidate action in an action execution condition DB.

The action priority determiner 132e may transmit the execution condition of the candidate action to the dialogue action manager 132b and the dialogue action manager 132b may add the execution condition according to each candidate action and update the action state of the dialogue and action state DB.

The action priority determiner 132e may search for a parameter that is needed to determine an action execution condition (hereinafter referred to as a condition determination parameter), from the context information DB, the long-term memory, the short-term memory, or the dialogue and action state DB. The action priority determiner 132e may also determine whether it is possible to execute the candidate action, using the searched parameter.

The action priority determiner 132e may determine whether it is possible to perform the candidate action using the parameter used to determine an action execution condition. In addition, the action priority determiner 132e may determine the priority of the candidate action based on whether to perform the candidate action and priority determination rules stored in the dialogue policy DB.

The action priority determiner 132e may provide the most needed service to a user by searching for an action directly connected to the user's utterance, context information and an action list related thereto and by determining a priority therebetween.

The action priority determiner 132e may transmit the possibility of the candidate action execution and the priority to the dialogue action manager 132b. The dialogue action manager 132b may update the action state of the dialogue and action state DB by adding the transmitted information.

The external information manager 132f may manage the external content list and related information and manage factor information required for external content query.

The experience information generator 132g may obtain the target and the target value for the ambiguous language based on the destination history information stored in the destination history database g1, the vehicle control information stored in the vehicle control history database g2, and speech information stored in the speech recognition usage database g3. The experience information generator 132g may also generate the target information including the obtained target and target value as experience information.

The speech information stored in the speech recognition usage database g3 may include the target and the target value selected by the user.

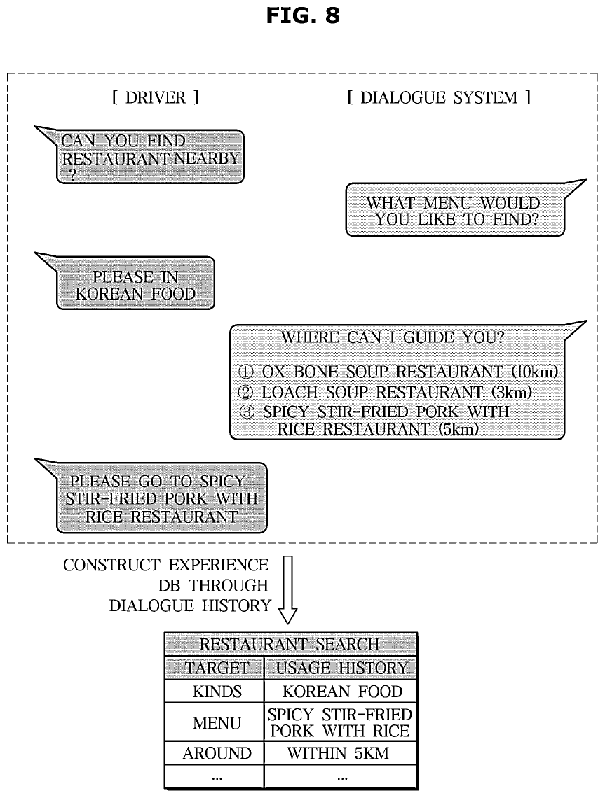

As illustrated in FIG. 8, in a state in which the driver and the dialogue system have a conversation, when it is determined that the user's intention is the destination (restaurant) search request and the ambiguous language is included in the uttered language, target information of ‘distance 5 km, pork rice bowl and Korean food’ corresponding to ‘surrounding, menu and type’, which is the ambiguous language, may be generated. This may be stored in the experience database g4 as the experience information.

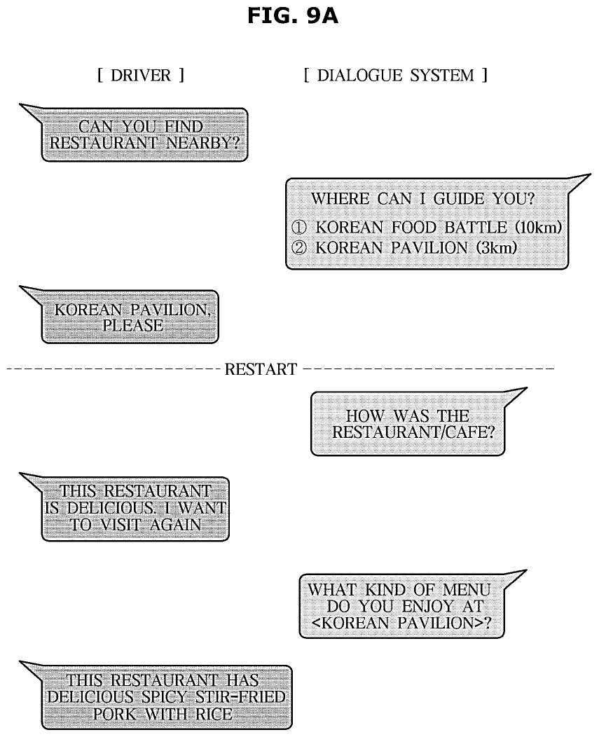

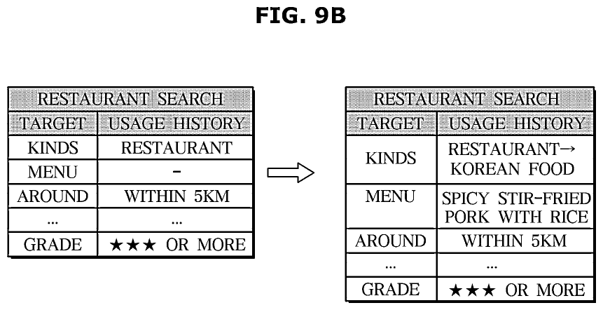

The experience information generator 132g may update the experience information stored in the experience database g4 based on the dialogue information before the restart and the dialogue information after the restart based on a restart time. This is described below with reference to FIGS. 9A and 9B.

As illustrated in FIG. 9A, from the dialogue information between the user and the dialogue system before restarting, when it is determined that the user's intention is the restaurant search request as the destination and that the ambiguous language is included in the uttered language, the experience information generator 132g may generate the target information of ‘distance 5 km, restaurant’ corresponding to ‘surrounding and type’, which is the ambiguous language, and may store it as the experience information in the experience database g4.

As illustrated in FIG. 9B, the experience information generator 132g may obtain the user's use information for restaurant use from the dialogue information between the user and the dialogue system after restarting and store the obtained use information as the experience information in the experience database g4.

The use information may include a use item or evaluation information.

In other words, the experience information generator 132g may add new information to the items without information among the usage history items in the experience database g4 through the dialogue information with the user after restarting.

The experience information generator 132g may generate new experience information based on current dialogue information or update the experience information stored in the experience database g4.

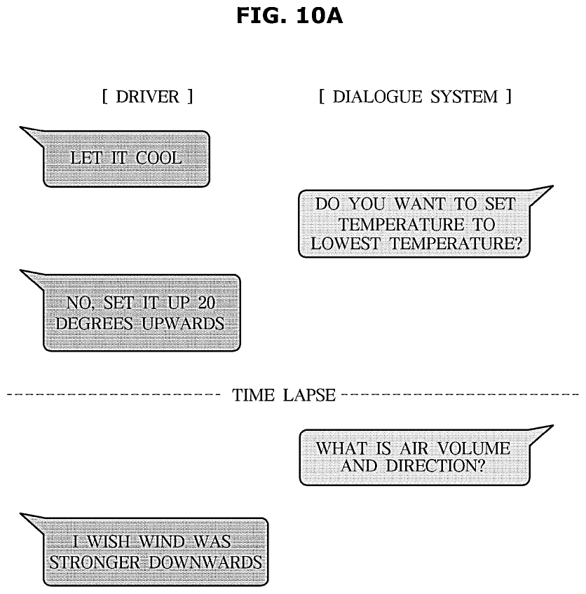

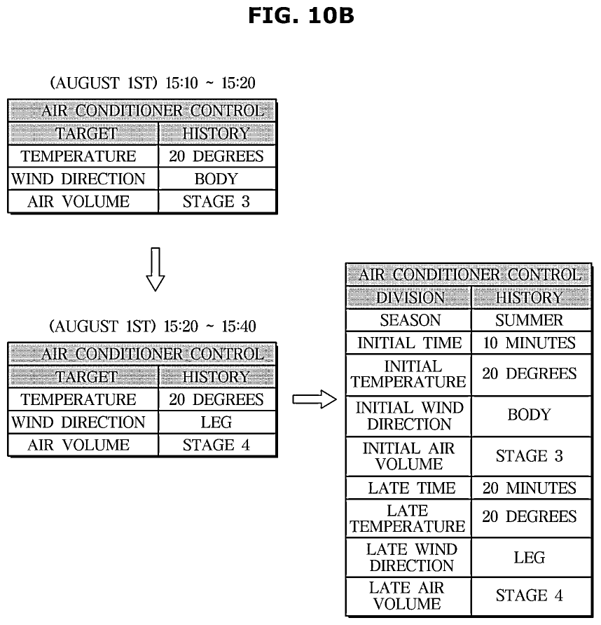

The experience information generator 132g may update the experience information stored in the experience database g4 based on dialogue information corresponding to a passage of time while driving. This is described below with reference to FIGS. 10A and 10B.

As illustrated in FIG. 10A, the experience information generator 132g may generate experience information corresponding to the control request of the air conditioner from the dialogue information between the user and the dialogue system, but may generate target information of ‘temperature, 20 degrees’ corresponding to ‘target and target value’ through the dialogue information with the user, and may store it as the experience information in the experience database g4.

As illustrated in FIG. 10B, the experience information generator 132g may obtain the user's use information for control of the air conditioner from the dialogue information between the user and the dialogue system after a certain time has elapsed, and may store the obtained use information as the experience information in the experience database g4.

For example, the experience information generator 132g may generate target information in a direction of a 4th stage and legs corresponding to ‘strongly and down’, which is the ambiguous language, from current control information of the air conditioner (i.e., a 3rd stage and a body), and may store this as the experience information in the experience database g4, but may be stored as control information of the air conditioner at a start-up start time and a start-up middle time.

The experience information generator 132g may update the experience information stored in the experience database g4 based on the control information of the air conditioner input from the second input device.

The experience information generator 132g may store the last usage history for the usage history in the experience information.

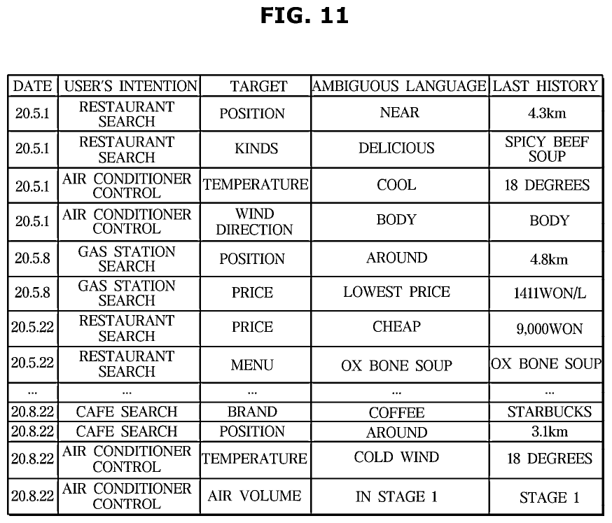

As illustrated in FIG. 11, the experience database g4 may store the target and the target value matched to user's intention and the ambiguous language, respectively.

The target value may be the last usage history.

The experience database g4 may store targets and target values matched to the user's intention and the ambiguous language by date, respectively.

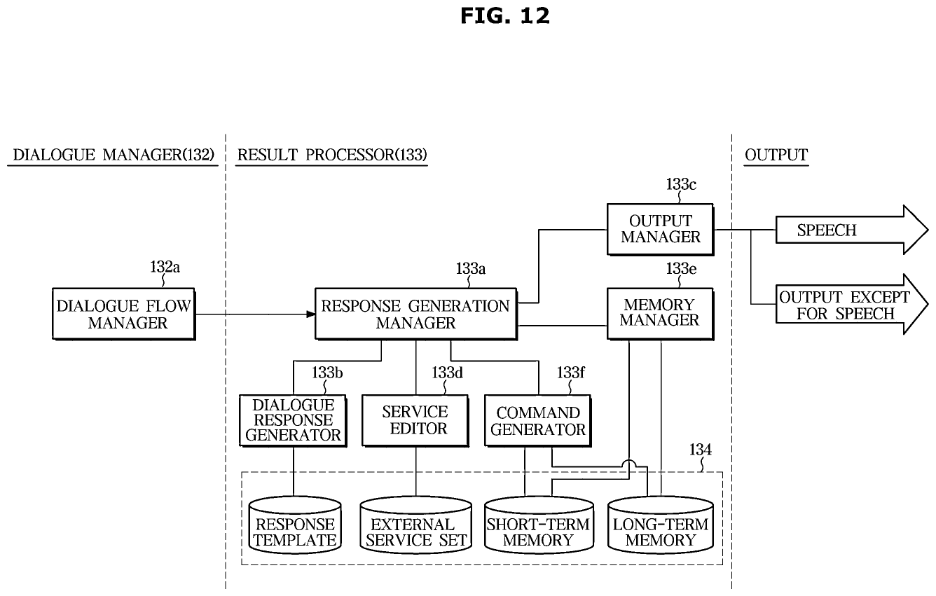

As illustrated in FIG. 12, a result processor 133 may include a response generation manager 133a, a dialogue response generator 133b, an output manager 133c, a service editor 133d, a memory manager 133e, and a command generator 133f.

The response that is output by corresponding to the user's utterance or context may include the dialogue response, the vehicle control, and the external content provision. The dialogue response may include an initial dialogue, a question, and an answer including information. The dialogue response may be stored in a database as a response template.

The response generation manager 133a may request that the dialogue response generator 133b and the command generator 133f generate a response that is needed to execute an action, which is determined by the dialogue manager 132.

For this, the response generation manager 133a may transmit information related to the action to be executed to the dialogue response generator 133b and the command generator 133f, where the information related to the action to be executed may include an action name and a parameter value. When generating a response, the dialogue response generator 133b and the command generator 133f may refer to the current dialogue state and action state.

The response generation manager 133a may transmit the dialogue response transmitted from the dialogue response generator 133b to the output manager 133c.

The response generation manager 133a may also transmit the response transmitted from the dialogue response generator 133b, the command generator 133f, or the service editor 133d, to the memory manager 133c.

The dialogue response generator 133b may generate a response in text, image, or audio type according to the request of the response generation manager 133a.

The dialogue response generator 133b may identify the history probability for each target and target value based on ambiguity analysis information in the ambiguity solver 132c, obtain the target value for each target with the highest history probability, and generate a response based on the obtained target value for each target.

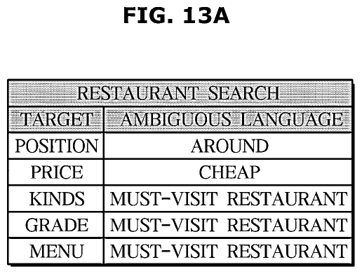

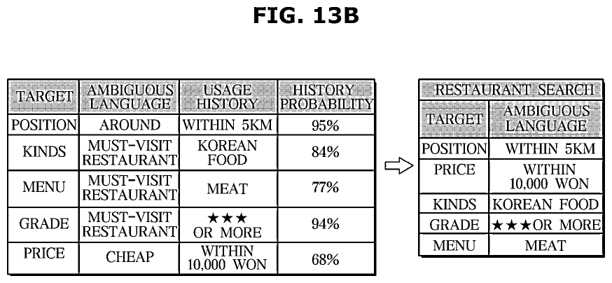

The dialogue response generator 133b may generate a plurality of responses according to a change in a combination of targets or a combination of target values. This is described below with reference to FIGS. 13A and 13B.

As illustrated in FIG. 13A, the dialogue response generator 133b may identify the user's intention from the utterance of ‘Find cheap must-visit restaurants nearby’. When the identified user's intention is the destination search request, the dialogue response generator 133b may obtain ‘neighborhood, cheap, and must-visit restaurants’, which is the ambiguous language related to the destination, and may identify the target corresponding to the obtained ‘neighborhood, cheap, and must-visit restaurant’.

As illustrated in FIG. 13b, the dialogue response generator 133b may obtain a target value corresponding to ‘around and target’ from the experience database, obtain a target value corresponding to ‘cheap and target’, obtain ‘must-visit restaurant and target’, and generate the plurality of responses based on the history probability of the target values, but may generate the plurality of responses based on an order of high history probability.

For example, the dialogue response generator 133b may generate a response in which a restaurant that sells meat among level 3 Korean food of 10,000 won or less within 5 km is a first priority destination.

The dialogue response generator 133b may generate a response to a restaurant that sells level 3 Korean food for less than 10,000 won within 5 km as the destination of the priority.

The dialogue response generator 133b may generate a response with a restaurant serving level 3 Korean food within 5 km as a third priority destination.

The dialogue response generator 133b may generate a response that makes a restaurant of level 3 within 5 km as a fourth priority destination.

The dialogue response generator 133b may search for a destination based on the information corresponding to the second priority if the destination is not found when the destination is searched for based on the information corresponding to the first priority. When the destination is not found when the destination is searched for based on the information corresponding to the second priority, the dialogue response generator 133b may search for the destination based on the information corresponding to the third priority. In other words, the dialogue response generator 133b may search for destinations in an order of search priority until the destination is searched.

The dialogue response generator 133b may display information about the destination corresponding to the search result.

The dialogue response generator 133b may extract a dialogue response format by searching for a response template and create a dialogue response by filling in the argument values required for the extracted dialogue response format. The generated dialogue response is delivered to the response generation manager 133a.

The dialogue response generator 133b may extract a dialogue response template by searching the response template and generate the dialogue response by filling the extracted dialogue response template with the parameter value. The generated dialogue response may be transmitted to the response generation manager 133.

The output manager 133c may output the generated text type response, image type response, or audio type response, output the command generated by the command generator 133f, or determine an order of the output when the output is plural.

The output manager 133c may determine an output timing, the output order, and an output position of the dialogue response generated by the dialogue response generator 133b and the command generated by the command generator 133f.

The output manager 133c may output a response by transmitting the dialogue response generated by the dialogue response generator 133b and the command generated by the command generator 133f to an appropriate output position at an appropriate order with an appropriate timing.

The output manager 133c may output a Text to speech (TTS) response via the speaker 142 and a text response via the display 141. When outputting the dialogue response in the TTS type, the output manager 133c may use a TTS module provided in the vehicle 1 or alternatively the output manager 133c may include a TTS module.

The output manager 133c may output the dialogue response generated by the dialogue response generator 133b through the speaker 141.

According to a control target, the command may be transmitted to the controller 150 or the communication device 170 for communicating with the external content server.

The service editor 133d sequentially or sporadically executes a plurality of service and collection results thereof to provide a service desired by a user.

The memory manager 133e manages the long-term memory and the short-term memory based on the output of the response generation manager 133a and the output manager 133c.

The command generator 133f generates a command for the vehicle control or the provision of service using an external content according to a request of the response generation manager 133a.

The command generator 133f may generate the command for executing a response to the user's utterance or context when it includes the vehicle control or external content provision. For example, when the action determined by the dialogue manager 132 is a control of the air conditioner, the window, the seats, or the AVN, the command for executing the control may be generated and transmitted to the response generation manager 133a.

When there are a plurality of commands generated by the command generator 133f, the service editor 133d may determine a method and order of executing the plurality of commands and transmit them to the response generation manager 133a.

In addition, when the user inputs an utterance expressing emotion, the specific domain or action may not be extracted from the user's utterance, but the dialogue system 130 may grasp the user's intention using surrounding environment information, vehicle state information, and user state information, and the like, and develop the dialogue.

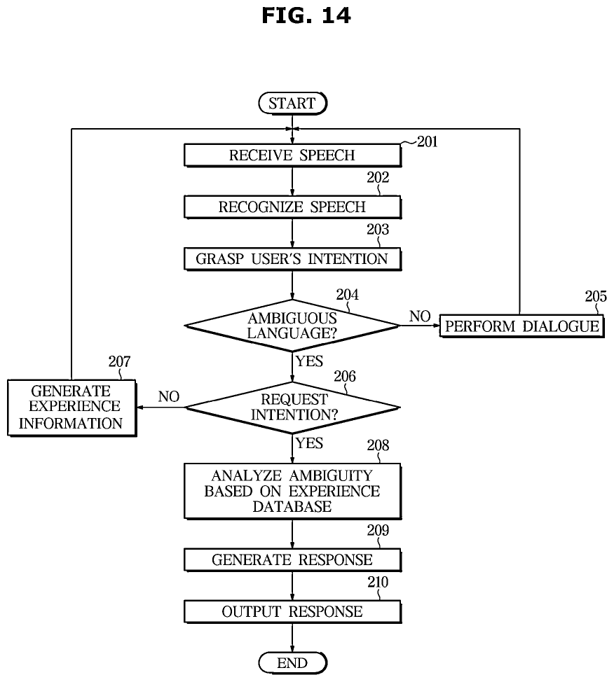

FIG. 14 is a control flowchart of a dialogue system according to an embodiment.

The dialogue system may receive the user's command by speech through the microphone (201). In this case, the dialogue system may receive sound and then convert the sound into the electrical signal (i.e., speech signal).

The dialogue system may recognize the user's speech based on the speech signal (202).

The dialogue system may convert the speech signal into utterance in the text type and recognize the user's intention by applying the natural language understanding algorithm to the user utterance (203).

More particularly, when the dialogue system converts the speech signal to utterance in the text type, the dialogue system may correct the utterance in the text type according to the user's intention and context rather than converting it as it is.

The dialogue system may also determine whether the converted text is for the ambiguous language (204).

When it is determined that the converted text is not a text for the ambiguous language (NO in 204), the dialogue system may continuously perform the dialogue with the user (205).

When it is determined that the converted text is a text for the ambiguous language (YES in 204), the dialogue system may determine whether the identified user's intention is a request intention (206).

The dialogue system may identify the user's intention contained in the utterance by applying natural language understanding to the utterance, perform morpheme analysis on the utterance in the text type, and then extract the domain from the utterance based on the morpheme analysis result. In other words, the dialogue system may perform natural language understanding.

The dialogue system may analyze the speech act of the utterance to analyze the intention of the user's utterance, identify the intention of the user's utterance based on the information, e.g., domain, entity name, and speech, and act corresponding to the utterance.

The dialogue system may also receive user commands received through the user's manipulation and images of the user captured by the camera and may also receive vehicle state information to grasp the user's intention or context.

When it is determined that the intention of the user's utterance is not the request intention (NO in 206), the dialogue system may obtain the target and the target value for the ambiguous language from the dialogue information and may generate the experience information based on the obtained target and target value (207).

When generating the experience information, the dialogue system may obtain the target and the target value for the ambiguous language based on the destination history information stored in the destination history database g1, the vehicle control information stored in the vehicle control history database g2, the speech information stored in the speech recognition usage database g3, and the current dialogue information. The dialogue system may also generate the target information including the obtained target and target value as the experience information.

The dialogue system may update the experience information stored in the experience database g4 based on the current dialogue information.

When it is determined that the intention of the user's utterance is the request intention (YES in 206), the dialogue system may analyze the ambiguous language based on the experience information stored in the experience database g4 (208), obtain the target and the target value corresponding to the analyzed ambiguity, and obtain the history probability corresponding to each of the target values.

The dialogue system may generate the response based on the history probability corresponding to each of the target values (209). The dialogue system may generate a plurality of responses based on the number of target values and the history probability.

When the user's intention is the destination search request intention, the dialogue system may identify the target values having the history probability greater than or equal to a reference probability among the plurality of responses to the ambiguous language and may generate the plurality of responses by combining the identified target values.

As a result of searching for the destination with the highest priority response, when the destination is not found, the dialogue system may search for the destination with the next priority response.

The dialogue system may output the information about the searched destination (210). In other words, the dialogue system may output the information about the searched destination as the image or the sound.

When the user's intention is the control intention of the air conditioner, the dialogue system may identify the target values having the history probability greater than or equal to the reference probability among the plurality of responses to the ambiguous language and may generate the plurality of responses by combining the confirmed target values.

The dialogue system may output the plurality of responses, and in this case, it is also possible to control the air conditioner based on the responses selected by the user.

The dialogue system may extract the dialogue response template by searching the response template and generate the dialogue response by filling the extracted dialogue response template with the parameter value.

The response may be generated as the response in text, image, or audio type.

The dialogue system may output the TTS response through the speaker 142.

The dialogue system may update the experience information stored in the experience database based on the information about the output response.

The dialogue system may update the experience information stored in the experience database based on the control information of the air conditioner received through the second input device during the dialogue with the user or the selection information of the destination.

The dialogue system may identify a revisit intention and the use information for the destination during the dialogue with the user and update the experience information stored in the experience database based on the identified revisit intention or use information.

For example, if the revisit intention is positive and the use information is meat, the ambiguous language may be set to the must-visit restaurant and the information of the destination targeting position may be stored.

The dialogue system may output destination recommendation information based on the experience information stored in the experience database while the driving.

The dialogue system may determine whether or not to drive regularly based on a driving history by date, day and time or a driving model for each time period, store information about regularly visited destinations, and output the destination recommendation information based on current date, day, and time information.

According to the embodiment of the disclosure, it may be possible to improve a recognition rate of speech recognition and provide the service that is appropriate for the user's intention or that is needed for the user by precisely recognizing the user's intention even when insufficient information is received during the dialogue based on the stored dialogue information and the target information of the user.

According to the disclosure, when a user utters an ambiguous language, unnecessary interactions may be reduced by removing the ambiguity, thereby providing a service with high usability. In other words, the disclosure may minimize the interaction between the user and the dialogue system.

The disclosure may propose a control of at least one function among a plurality of functions provided in the vehicle and may enable a smooth dialogue between the system and a plurality of speakers.

Through the dialogue function, it may be possible to improve the quality of the vehicle, increase the commerciality, increase the satisfaction of the user, and improve the convenience of the user and the safety of the vehicle.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a non-transitory computer-readable recording medium.

The non-transitory computer-readable recording medium may include all types of recording media storing commands that may be interpreted by a computer. For example, the non-transitory computer-readable recording medium may be ROM, RAM, a magnetic tape, a magnetic disc, flash memory, an optical data storage device, and the like.

Embodiments of the disclosure have thus far been described with reference to the accompanying drawings. It should be apparent to those of ordinary skill in the art that the disclosure may be practiced in other forms than the embodiments as described above without changing the technical idea or essential features of the disclosure. The above embodiments are only by way of example and should not be interpreted in a limited sense.

What is claimed is:

1. A dialogue system comprising:
a storage configured to store target information about a target and a target value for ambiguous language;
a first input device configured to receive speech signals;
a dialogue manager configured to:
convert the speech signals received in the first input device into text;
determine a user's intention based on the received speech signals; and
based on determining that the determined user's intention corresponds to a request intention and the converted text corresponds to the ambiguous language, obtain the target and the target value corresponding to the ambiguous language from the target information stored in the storage; and
a result processor configured to generate a response based on the target and the target value obtained from the dialogue manager, and to control an output of the generated response.

2. The dialogue system according to claim 1, wherein, in response to a presence of a speech signal corresponding to a query for the ambiguous language among the received speech signals, the dialogue manager is configured to update the target information corresponding to the ambiguous language stored in the storage based on the speech signal corresponding to the query.

3. The dialogue system according to claim 1, further comprising:
a second input device configured to receive user inputs except for a speech,
wherein, in response to a presence of a user input corresponding to a query for the ambiguous language among the user inputs received through the second input device, the dialogue manager is configured to update the target information corresponding to the ambiguous language stored in the storage based on the user input corresponding to the query.

4. The dialogue system according to claim 1, further comprising:
a second input device configured to receive user inputs except for a speech,
wherein:
the dialogue manager is configured to obtain a history probability of the target value for each ambiguous language based on selection information of the target value for each ambiguous language received through the first and second input devices; and
the result processor is configured to generate a plurality of responses based on the history probability for the obtained target value for each ambiguous language, and to output the generated plurality of responses.

5. The dialogue system according to claim 1, wherein the dialogue manager is configured to:
based on dialogue information with the user, determine whether the ambiguous language exists;
in response to determining that the ambiguous language exists, based on the dialogue information, generate the target information for the ambiguous language as experience information based on the dialogue information; and
store the generated experience information in the storage.

6. The dialogue system according to claim 1, wherein the ambiguous language comprises a language that modifies the target.

7. A vehicle comprising:
a first input device configured to receive speech signals;
a storage configured to store target information about a target and a target value for ambiguous language; and
a dialogue system configured to:
convert the speech signals received in the first input device into text;
determine a user's intention based on the received speech signals;
based on determining that the determined user's intention corresponds to a request intention and the converted text corresponds to the ambiguous language, obtain the target and the target value corresponding to the ambiguous language from the target information stored in the storage;
generate a response based on the obtained target and target value; and
control an output of the generated response.

8. The vehicle according to claim 7, further comprising:
a display configured to output the generated response as an image; and
a speaker configured to output the generated response as audio.

9. The vehicle according to claim 7, wherein, in response to a presence of a speech signal corresponding to a query for the ambiguous language among the received speech signals, the dialogue system is configured to update the target information corresponding to the ambiguous language stored in the storage based on the speech signal corresponding to the query.

10. The vehicle according to claim 7, further comprising:
a second input device configured to receive user inputs except for a speech,
wherein, in response to a presence of a user input corresponding to a query for the ambiguous language among the user inputs received through the second input device, the dialogue system is configured to update the target information corresponding to the ambiguous language stored in the storage based on the user input corresponding to the query.

11. The vehicle according to claim 7, further comprising:
a second input device configured to receive user inputs except for a speech,
wherein the dialogue system is configured to:
obtain a history probability of the target value for each ambiguous language based on selection information of the target value for each ambiguous language received through the first and second input devices;
generate a plurality of responses based on the history probability for the obtained target value for each ambiguous language; and
output the generated plurality of responses.

12. The vehicle according to claim 7, wherein the dialogue system is configured to:
based on dialogue information with the user, determine whether the ambiguous language exists;
in response to determining that the ambiguous language exists, based on the dialogue information, generate the target information for the ambiguous language as experience information based on the dialogue information; and
store the generated experience information in the storage.

13. The vehicle according to claim 7, further comprising:
a controller configured to control at least one of an air conditioner, windows, doors, seats, an audio/video/navigation (AVN) device, a heater, a wiper, side mirrors, internal lamps, or external lamps in response to the response output from the dialogue system.

14. The vehicle according to claim 13, wherein, in response to the user's request intent being a destination search request intent, the dialogue system is configured to:
generate the target information for the ambiguous language as experience information based on the dialogue information before a restart and the dialogue information after the restart; and
store the generated experience information in the storage.

15. The vehicle according to claim 13, wherein the dialogue system is configured to generate experience information based on destination history information, speech recognition usage information, and control information of at least one device.

16. The vehicle according to claim 13, wherein the dialogue system is configured to:
obtain control information for at least one device based on dialogue information according to a passage of time while driving; and
generate experience information based on the obtained control information of at least one device.

17. A method of controlling a dialogue system comprising:
receiving a speech signal;
converting the received speech signal into text;
identifying an intention of a user's utterance based on the converted text;
in response to the identified intention of the user's utterance being a request intention, and the converted text being a text for ambiguous language, obtaining target information corresponding to the ambiguous language based on experience information stored in an experience database;
determining an action corresponding to the obtained target information;
generating a response corresponding to the determined action; and
outputting the generated response.

18. The method according to claim 17, further comprising:
generating the experience information based on the output speech signal and the received speech signal; and
storing the generated experience information in the experience database.

19. The method according to claim 17, further comprising:
based on receiving user inputs except for a speech through a second input device, determining whether a user input corresponding to a query for the ambiguous language exists among the received user inputs; and
in response to determining that there is the user input corresponding to the query for the ambiguous language, updating the target information corresponding to the ambiguous language stored in the experience database based on the user input corresponding to the query.

20. The method according to claim 17, wherein the outputting of the generated response comprises:
obtaining a history probability of a target value for each ambiguous language based on selection information of the target value for each ambiguous language received through first and second input devices;
generating a plurality of responses based on the history probability for the obtained target value for each ambiguous language; and
outputting the generated plurality of responses.
